(19) United States
(12) Patent Application Publication
(10) Pub. No.: US 2024/0102176 A1
(43) Pub. Date: Mar. 28, 2024

(54) ANTICORROSIVE COMPOSITIONS AND METHODS WITH SUPRAMOLECULAR STRUCTURES

(71) Applicant: BPS JUST ENERGY TECHNOLOGY, LLC, Argyle, TX (US)

(72) Inventors: Jason L. HURST, Roanoke, TX (US); Donna Jean SHOTWELL, Eufaula, OK (US); Robert A. GEIGER, Denton, TX (US)

(21) Appl. No.: 18/264,273

(22) PCT Filed: Feb. 1, 2022
(86) PCT No.: PCT/US2022/014751

§ 371 Date: Aug. 4, 2023

Related U.S. Application Data
(60) Provisional application No. 63/145,818, filed on Feb. 4, 2021.

(30) Foreign Application Priority Data
Feb. 16, 2021 (EP) 21157381.1

(51) Int. Cl. C23F 11/14; C23F 11/167; C23F 11/18

(52) U.S. Cl. CPC C23F 11/143; C23F 11/149; C23F 11/1673; C23F 11/184

(57) ABSTRACT

Compositions with supramolecular structures for use in anticorrosive methods include a corrosion inhibitor; a supramolecular host chemical or a supramolecular guest chemical configured to engage in host-guest chemistry with the corrosion inhibitor; and a solvent. Methods of inhibiting corrosion on a surface or reducing the amount of anticorrosive composition within a system include adding an anti-corrosively effective amount of the composition to the system.

### FIELD OF THE INVENTION

The present disclosure relates to anticorrosive compositions that include a corrosion inhibitor having supramolecular structures that increase the activity of the corrosion inhibitor, and methods of using the anticorrosive compositions to decrease corrosion rates or the amount of active ingredient needed to prevent corrosion degradation.

### BACKGROUND OF THE DISCLOSURE

Corrosion inhibitors have importance as individual inhibitors and as a component in chemical formulations. Corrosion inhibitors are extensively used worldwide in a variety of applications to minimize the rate of corrosion on metal surfaces subjected to any specific environment. With increased and repeated use of corrosion inhibitors, there has been a large concern with sustainability and effectiveness. A wide assortment of active chemical agents are found in these products, and of the currently active chemicals that are utilized in this area, many have been used for hundreds of years.

Considerable progress has been made in understanding the mechanisms of corrosion and the methods used to apply protective inhibitors. The advancement in discovery applies to aqueous-based inhibitors for treatment of most water-based fluids. The emphasis over the last few decades has been on the improvement of inhibition technology where most common inhibitors are used in industrial cooling water systems, oil and gas, coatings, pickling, lubricants, concrete industry, and common household facilities. However, this developmental process for specific inhibitors in specific environments takes considerable time and often requires a lengthy and costly research and development process.

Even though these techniques overcome different and difficult situations, there has been a growing concern on increasing the effectiveness of corrosion inhibitors with approved active chemicals. Accordingly, improved compositions and methods are needed to boost the anticorrosion activity of currently approved inhibitors.

### BRIEF DESCRIPTION OF THE DRAWINGS

The present disclosure is best understood from the following detailed description when read with the accompanying figures.

FIG. 1 is a graph comparing the corrosion rates of the 0.1:1 (supramolecular host chemical:corrosion inhibitor) compositions from Example 1 according to aspects of the present disclosure;

FIG. 2 is a graph comparing the corrosion rates of the 0.2:1 (supramolecular host chemical:corrosion inhibitor) compositions from Example 1 according to aspects of the present disclosure;

FIG. 3 is a graph comparing the corrosion rates of the 0.4:1 (supramolecular host chemical:corrosion inhibitor) compositions from Example 1 according to aspects of the present disclosure;

FIG. 4 is a graph showing the average percent reduction in corrosion rates measured for the compositions from Example 1 according to aspects of the present disclosure;

FIG. 5 is a graph comparing the corrosion rates of the supramolecular host chemical:corrosion inhibitor compositions from Example 2 at a treatment rate of 25 ppm according to aspects of the present disclosure;

FIG. 6 is a graph comparing the corrosion rates of the supramolecular host chemical:corrosion inhibitor compositions from Example 2 at a treatment rate of 100 ppm according to aspects of the present disclosure;

FIG. 7 is a graph showing the average improvement in corrosion protection of the supramolecular host chemical:corrosion inhibitor compositions from Example 2 at a treatment rate of 25 ppm according to aspects of the present disclosure; and

FIG. 8 is a graph showing the average improvement in corrosion protection of the supramolecular host chemical:corrosion inhibitor compositions from Example 2 at a treatment rate of 100 ppm according to aspects of the present disclosure.

### DETAILED DESCRIPTION OF THE PREFERRED EMBODIMENTS

The present disclosure is directed to anticorrosive compositions that increase efficiency by the formation of supramolecular structures. As used herein, “anticorrosive” means, without limitation, used to inhibit or prevent corrosion. Advantageously, different chemistries mixed with supramolecular structures have been found to increase the activity of current and common corrosion inhibitors (also referred to herein as anticorrosive agents), while minimizing the environmental impact by reduction of the amount of raw material required.

In certain embodiments, the anticorrosive compositions include (1) a corrosion inhibitor, such as an anodic corrosion inhibitor, a cathodic corrosion inhibitor, and/or a mixed corrosion inhibitor; (2) a supramolecular host or guest chemical configured to engage in host-guest chemistry with the corrosion inhibitor; and (3) a solvent, such as water, an alcohol, a glycol, or an oil. In some embodiments, formulation additives, such as pH buffers, colorants, adjuvants, stabilizers, or rheology modifiers are included in the anticorrosive composition, and any suitable type and amount of each, in any combination, may be used in the present anticorrosive compositions based on the guidance provided herein. Suitable pH buffers or neutralizers include citric acid, phosphate buffers, sodium hydroxide, and hydrochloric acid. Any kind of dye or pigment may serve as the colorant. Suitable adjuvants include all kinds of surfactants that are used to spread, stick onto, or penetrate different types of surfaces. Suitable rheology modifiers include guar gums, xanthan gum, celluloses, carbomers, and cross-linked polymers. Any kind of additive may be included in the anticorrosive composition, as long as it does not interfere with the action of the anticorrosive agent. Advantageously, the supramolecular host or guest chemical forms supramolecular structures with the anticorrosive agent. Such supramolecular structures or assemblies may take the form of, e.g., micelles, liposomes, nanostructures, or nanobubbles.

In various embodiments, the corrosion inhibitor in the anticorrosive composition includes an anodic corrosion inhibitor (e.g., a corrosion inhibitor that acts by forming an oxide on a metal surface), a cathodic corrosion inhibitor (e.g., a corrosion inhibitor that acts by slowing the cathodic reaction itself or selectively precipitating on cathodic areas to limit the diffusion of reducing species to the surface), or a mixed corrosion inhibitor (e.g., a corrosion inhibitor that works by reducing both the cathodic and anodic reactions). As used herein, “corrosion inhibitor” or “anticorrosive agent” means (1) a chemical compound that, when added to a fluid (such as a liquid or a gas), decreases the corrosion rate of a material, typically a metal or an alloy, that directly or indirectly comes into contact with the fluid, and/or (2) a chemical compound that, when applied to a surface of a material, decreases the corrosion rate of the material when the material comes into contact with a fluid.

In an exemplary embodiment, the corrosion inhibitors of this disclosure are used to prevent or control the effects of corrosion on a metallic surface. Didecyl dimethyl ammonium chloride, triethyl phosphate, cinnamaldehyde, benzyl alkyl pyridinyl quaternary ammonium chloride, citric acid, polyphosphate-quaternary ammonium chloride compounds, alkyl pyridine quaternary chloride, diethyl sulfate quaternary imidazoline, coco-benzyl quaternary chloride, silicates (e.g., sodium silicate), phosphates (e.g., sodium phosphate), molybdates, tungstates (e.g., sodium tungstate) benzotriazole/mercaptobenzothiazole, 2-pho sphonobutane-1,2,4-tric arboxylic acid, hydroxyethylidene diphosphonic acid, zinc sulphate, benzotriazole, sodium hexametaphosphate and a co-polymer of phosphate and chromate, alkylalkanolamine based compounds, thioglycolic acid salts, sodium gluconate, tolyltriazole, triethanolamine phosphate, and a disodium salt of ethylenediaminetetraacetic acid are each a suitable example of a corrosion inhibitor, and combinations of corrosion inhibitors may be used in the compositions and methods of the present disclosure. One of ordinary skill in the art recognizes that these types of corrosion inhibitors are merely exemplary, and that this list is neither exclusive nor limiting to the compositions and methods described herein.

In certain embodiments, the corrosion inhibitor is present in an amount of about 1 percent to about 90 percent by weight of the anticorrosive composition, for example about 25 percent to about 75 percent by weight of the anticorrosive composition or about 30 percent to about 70 percent by weight of the anticorrosive composition.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent and non-aqueous solvent.

Host chemicals may include a charge, may have magnetic properties, or both. Host chemicals may be soluble or insoluble in the solvent system. If insoluble in the solvent, the particle size of the host chemical is typically greater than 100 nanometers, and the host chemical does not include nanoparticles or nanostructures. Suitable supramolecular host chemicals include cavitands, cryptands, rotaxanes, catenanes, minerals (e.g., clays, silica, or silicates), or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH₂]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another but cannot be separated unless covalent bond breakage occurs.

Suitable supramolecular guest chemicals include cyanuric acid, minerals (e.g., clays, silica, or silicates), water, and melamine, and are preferably selected from cyanuric acid or melamine, or a combination thereof. Guest chemicals may have a charge, may have magnetic properties, or both. Guest chemicals may be soluble or insoluble in the solvent system. If the guest chemical is insoluble in the solvent, the particle size is generally greater than 100 nanometers, and the guest chemical is not in the form of nanoparticles or nanostructures.

The supramolecular host chemical or the supramolecular guest chemical is present in the anticorrosive composition in any suitable amount but is generally present in the anticorrosive composition in an amount of about 1 percent to about 90 percent by weight of the anticorrosive composition. In certain embodiments, the supramolecular host chemical or supramolecular guest chemical, or host and guest chemical combination, is present in an amount of about 10 percent to about 80 percent by weight of the anticorrosive composition, for example, 10 percent to about 50 percent by weight of the anticorrosive composition.

Any aqueous or non-aqueous solvent may be used, including for example water, an alcohol, a glycol, or an oil. Typically, an aqueous solvent is used, and water is used as a preferred aqueous solvent. The solvent is typically present in an amount that is at least sufficient to partially and preferably substantially dissolve any solid components in the anticorrosive composition. Water (or other polar solvent) is present in any suitable amount but is generally present in the anticorrosive composition in an amount of about 0.5 percent to about 80 percent by weight of the composition. In certain embodiments, water is present in an amount of about 5 percent to about 75 percent by weight of the anticorrosive composition, for example, 50 percent to about 70 percent by weight of the anticorrosive composition. In various embodiments, the solvent partially dissolves one more components of the anticorrosive composition. In some embodiments, the solvent is selected to at least substantially dissolve (e.g., dissolve at least 90%, preferably at least about 95%, and more preferably at least about 99% or 99.9%, of all the components) or completely dissolve all of the components of the anticorrosive composition.

The order of addition of the components of the anticorrosive composition can be important to obtain stable supramolecular structures or assemblies in the final mixture. The order of addition is typically: (1) a solvent, (2) any additives, (3) a corrosion inhibitor; and (4) a supramolecular host chemical or a supramolecular guest chemical. Once these components are fully mixed, supramolecular structures can be formed.

The anticorrosive compositions can be applied to a surface or added to a fluid in any suitable manner to reduce the rate of corrosion of a metallic surface in contact with the fluid or an intermediate non-metallic surface associated with the fluid. In some embodiments, a fluid system is dosed at about 2 parts per million (ppm) to about 200 ppm of the anticorrosive composition, for example at about 10 ppm to about 150 ppm or about 25 ppm to about 100 ppm of the anticorrosive composition. In several embodiments, the applied anticorrosive composition inhibits corrosion of a metallic surface or reduces the corrosion rate on a metallic surface for a period of time. For example, the rate of corrosion on one or more metallic coupons may be reduced for a duration of about 30 days. It should be understood, without being bound by theory, that the present anticorrosive compositions may include reduced amounts of corrosion inhibitors to achieve the same or better anticorrosive effects compared to anticorrosive compositions including conventional corrosion inhibitors (including the same corrosion inhibitors described herein) that are free or substantially free of a supramolecular host chemical or a supramolecular guest chemical.

The following examples are illustrative of the compositions and methods discussed above and are not intended to be limiting.

### EXAMPLES

### Example 1: Compositions for 30-Day Corrosion Screening

Corrosion rates were measured using a 30-day corrosion screening. Six (6) corrosion inhibitors were tested and formulated into compositions. The six corrosion inhibitors were: (A) didecyl dimethyl ammonium chloride (BTC® 1010-E, commercially available from Stepan Company); (B) triethyl phosphate and cinnamaldehyde mixture (AI-600, commercially available from APChem®); (C) benzyl alkyl pyridinyl quaternary ammonium chloride (StarQuat™ BAP 75, commercially available from StarChem®, LLC); (D) an environmentally safe corrosion inhibitor (CorrosX, commercially available from Heartland Energy Group, Ltd.); (E) polyphosphate-quaternary ammonium chloride (StarSurf Phos N95, commercially available from StarChem®, LLC); and (F) polyphosphate-quaternary ammonium chloride (Dextrol™ 0C110, commercially available from Ashland Inc.).

A 4% (w/w) solution was prepared for each corrosion inhibitor utilizing distilled water. The supramolecular host chemical (SymMAX™ supramolecular host or guest water mixture commercially available from Shotwell Hydrogenics, LLC or BPS Shotwell) was then added at a ratio of 0.1:1, 0.2:1, 0.4:1 (w/w) into each 4% solution. Control compositions without the supramolecular host chemical were also prepared giving a total of 36 compositions that were tested.

A synthetic salt brine was utilized to accelerate corrosion during the 30-day study by preparing a solution using the composition provided in Table 1 (ASTM D114).

TABLE 1
COMPOSITION OF SYNTHETIC BRINE

| Component | Percent (w/w) |
|---|---|
| Magnesium Chloride | 55.56% |
| Calcium Chloride | 5.79% |
| Strontium Chloride | 0.21% |
| Potassium Chloride | 6.95% |
| Sodium Bicarbonate | 2.01% |
| Potassium Bromide | 1.00% |
| Boric Acid | 0.27% |
| Sodium Fluoride | 0.03% |
| Deionized Water | 28.18% |

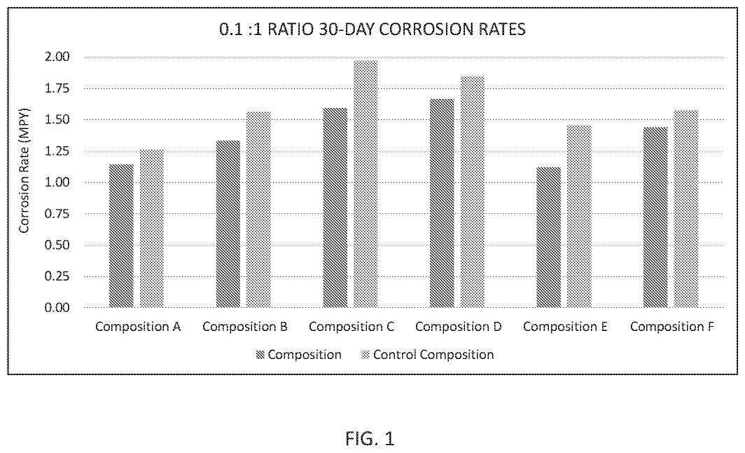

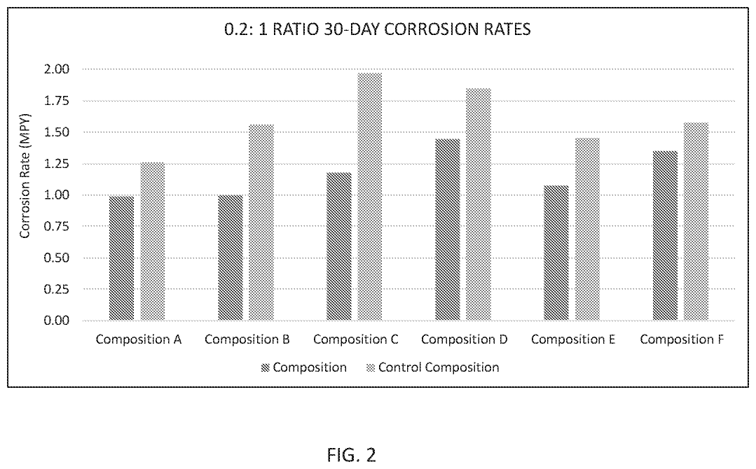

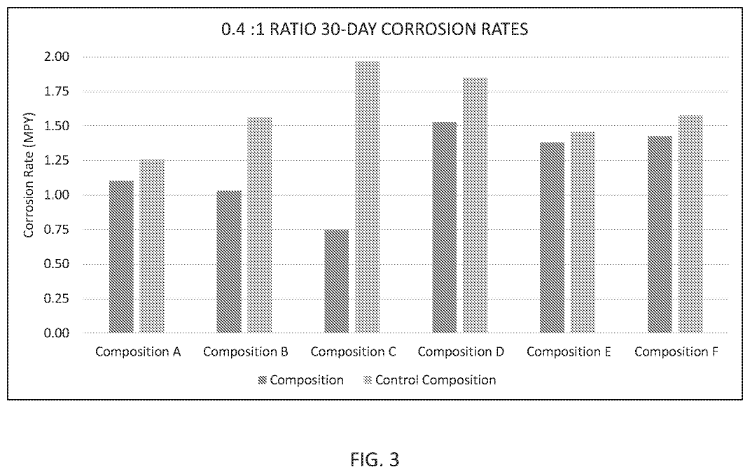

Corrosion testing was completed by placing a carbon steel coupon that was acquired from VK Enterprises, Inc. into the synthetic brine that was treated at 25 ppm for all solutions. Samples were placed into a laboratory oven at an elevated temperature of 180° C. for an elapsed time of 30 days. Once completed, the samples were removed from the oven and coupons were cleaned. The total metal loss was measured by comparing initial weight to final weight of the coupons. All results are provided in Tables 2-4, and the results are illustrated in FIGS. 1-3.

TABLE 2
0.1:1 Ratio 30-DAY CORROSION RATES

| | Corrosion Rate (mils per year or mpy) | | |
|---|---|---|---|
| | | Control | |
| | Composition | Composition | % Reduction |
| | with | Without | in MPY to |
| | Supramolecular | Supramolecular | the Control |
| Composition | Host | Host | Composition |
| Composition A | 1.142 | 1.258 | 9.22 |
| Composition B | 1.333 | 1.561 | 14.61 |
| Composition C | 1.592 | 1.968 | 19.11 |
| Composition D | 1.664 | 1.847 | 9.91 |
| Composition E | 1.119 | 1.454 | 23.04 |
| Composition F | 1.439 | 1.576 | 8.69 |

TABLE 3
0.2:1 Ratio 30-DAY CORROSION RATES

| | Corrosion Rate (mils per year or mpy) | | |
|---|---|---|---|
| | | Control | |
| | Composition | Composition | % Reduction |
| | with | Without | in MPY to |
| | Supramolecular | Supramolecular | the Control |
| Composition | Host | Host | Composition |
| Composition A | 0.990 | 1.258 | 21.30 |
| Composition B | 0.996 | 1.561 | 36.19 |
| Composition C | 1.177 | 1.968 | 40.19 |
| Composition D | 1.446 | 1.847 | 21.71 |
| Composition E | 1.076 | 1.454 | 26.00 |
| Composition F | 1.350 | 1.576 | 14.34 |

TABLE 4
0.4:1 Ratio 30-DAY CORROSION RATES

| | Corrosion Rate (mils per year or mpy) | | |
|---|---|---|---|
| | | Control | |
| | Composition | Composition | % Reduction |
| | with | Without | in MPY to |
| | Supramolecular | Supramolecular | the Control |
| Composition | Host | Host | Composition |
| Composition A | 1.102 | 1.258 | 12.4 |
| Composition B | 1.030 | 1.561 | 34.01 |
| Composition C | 0.747 | 1.968 | 62.04 |
| Composition D | 1.529 | 1.847 | 17.22 |
| Composition E | 1.379 | 1.454 | 5.16 |
| Composition F | 1.425 | 1.576 | 9.58 |

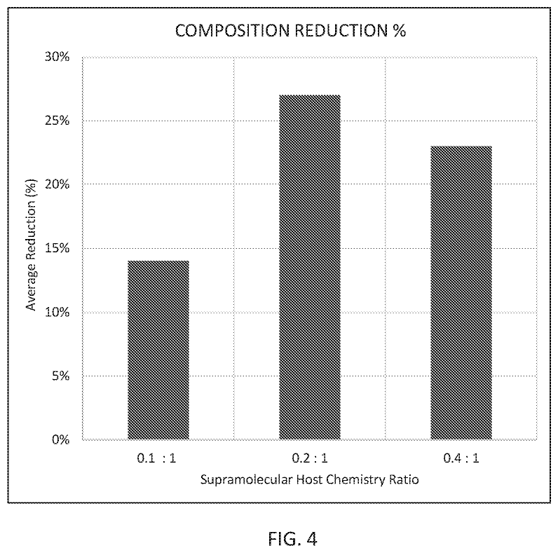

As seen in FIGS. 1-3, there was a positive impact on reducing the corrosion rate with the anticorrosive compositions exhibiting supramolecular host-guest chemistry according to the disclosure. The overall reduction in corrosion rates seen in FIG. 4 and provided in Table 5 can aid in operating expenses from routine maintenance to costly repairs and help significantly reduce the overall impact (including environmental impact and inhibitor cost) in industrial cooling water systems, oil and gas, coatings, pickling, lubricants, concrete industry, common household facilities, etc., with compositions of the disclosure.

TABLE 5
AVERAGE REDUCTION IN CORROSION RATE

| Ratio Supramolecular Host | Average Reduction |
|---|---|
| Chemical:Corrosion Inhibitor | in Corrosion Rate |
| 0.1:1 | 14% |
| 0.2:1 | 27% |
| 0.4:1 | 23% |

### Example 2: Compositions for 24 Hour Wheel Test Corrosion Screening

Corrosion rates were measured using a modified Wheel Test with NACE 1D182 publication as a point of reference for corrosion screening. Three (3) corrosion inhibitors were tested and formulated into compositions. The three corrosion inhibitors were: (G) 75% alkyl pyridine quaternary chloride (ICS APQ, commercially available from Integrated Chemical Services Inc.); (H) diethyl sulfate quaternary imidazoline (ICS-480, commercially available from Integrated Chemical Services Inc.); and (I) 80% coco-benzyl quaternary chloride (ADBAC) (ICS-CB Q, commercially available from Integrated Chemical Services Inc.).

A 20% (w/w) solution was prepared for each corrosion inhibitor utilizing compositions G through I with a 1% (w/w) supramolecular host chemical (SymMAX™ supramolecular host or guest water mixture commercially available from Shotwell Hydrogenics, LLC or BPS Shotwell). Control compositions without the supramolecular host chemical were also prepared giving a total of 6 compositions.

The standard wheel test method was carried out on the prepared samples. Testing was outsourced to Lightning Corrosion, LLC in Tomball, TX. Using the composition provided in Table 1 (ASTM D114), the synthetic salt brine was sparged with carbon dioxide until saturated. Samples were prepared by adding 10 mL of LVT® 200: Hydrotreated Light Distillate (commercially available from Deep South Chemical, Inc.). to 90 mL of brine. The composition samples, prepared in duplicates, were formulated to contain 20% of the corrosion inhibitor base by weight, and were dosed at 25 ppm and 100 ppm respectfully. After dosing, a pre-weighed 1″ X ¼″ 1080 steel corrosion coupon (commercially available through VK Enterprises, Edmond OK) was placed in the solution, and the test samples were placed in an enclosed rotating assembly and heated to 175° F. for 24 hours.

Upon completion of the test, the coupons were removed from the sample bottles, rinsed, dried, weighed, and corrosion rates calculated.

TABLE 6
24 HR - WHEEL TEST CORROSION RATES at 25 PPM

| | Corrosion Rate (mils per year or mpy) | | |
|---|---|---|---|
| | | Control | |
| | Composition | Composition | % Reduction |
| | with | Without | in MPY to |
| | Supramolecular | Supramolecular | the Control |
| Composition | Host | Host | Composition |
| Composition G | 17.9 | 25.2 | 28.97 |
| Composition H | 26.3 | 30.9 | 14.89 |
| Composition I | 32.6 | 35.6 | 8.43 |

TABLE 7
24 HR - WHEEL TEST CORROSION RATES at 100 PPM

| | Corrosion Rate (mils per year or mpy) | | |
|---|---|---|---|
| | | Control | |
| | Composition | Composition | % Reduction |
| | with | Without | in MPY to |
| | Supramolecular | Supramolecular | the Control |
| Composition | Host | Host | Composition |
| Composition G | 9.5 | 14.2 | 33.10 |
| Composition H | 12.3 | 14.9 | 17.45 |
| Composition I | 11.0 | 12.3 | 10.57 |

TABLE 8
AVERAGE IMPROVEMENT IN CORROSION
RATE AT 25 PPM AND 100 PPM

| | % Reduction in | % Reduction in |
|---|---|---|
| | MPY to the Control | MPY to the Control |
| Composition | Composition (25 ppm) | Composition (100 ppm) |
| Composition G | 28.97 | 33.10 |
| Composition H | 14.89 | 17.45 |
| Composition I | 8.43 | 10.57 |

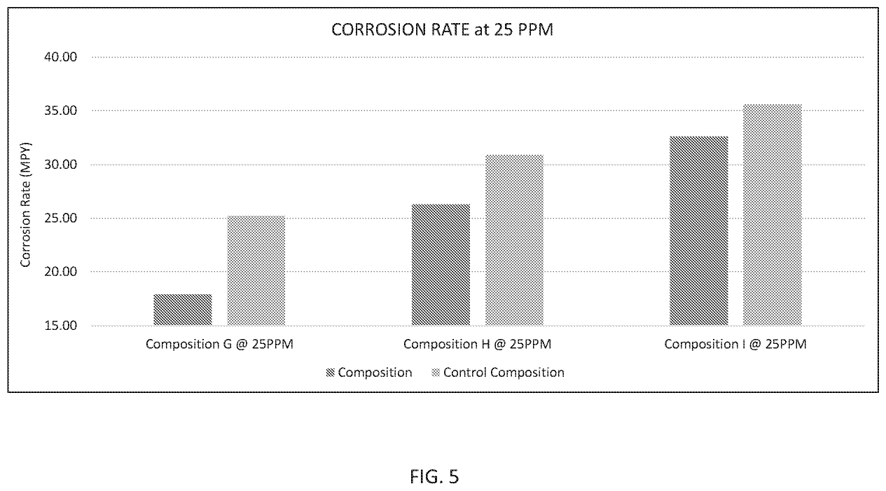

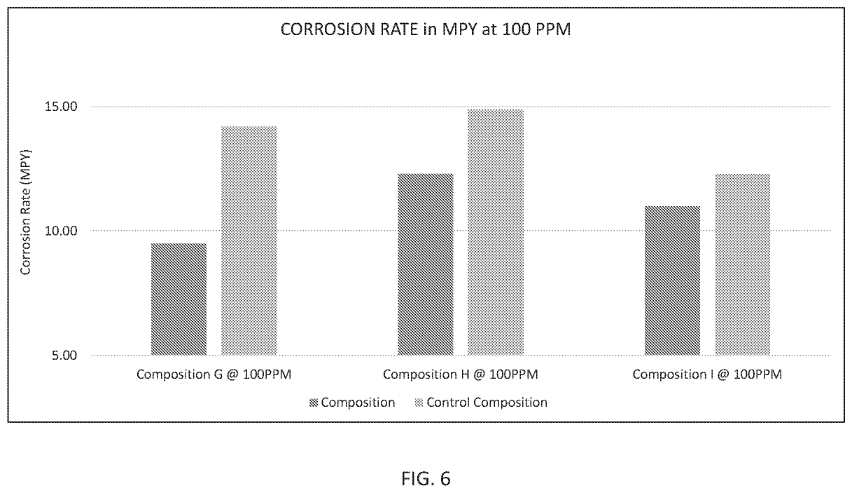

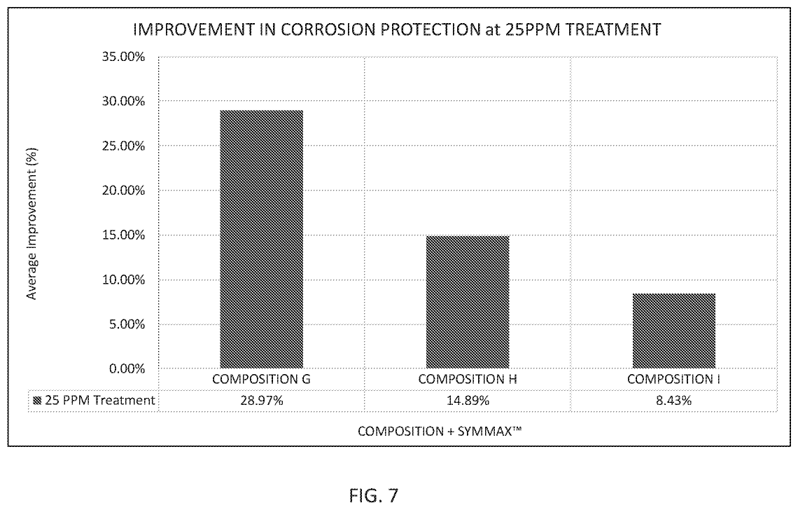

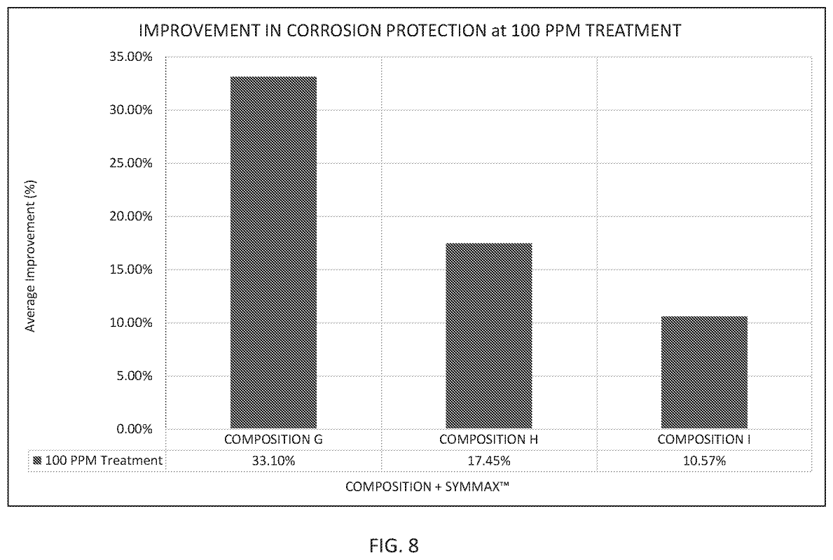

As seen in FIGS. 5 and 6 and provided in Table 6 and 7, there was a positive impact on reducing the corrosion rate with the anticorrosive compositions exhibiting supramolecular host-guest chemistry according to the disclosure. The overall improvement in corrosion protection can be seen in Table 8, FIG. 7, and FIG. 8, which can aid in the reduction to operating expenses from routine maintenance to costly repairs and help significantly reduce the overall impact (including environmental impact and inhibitor cost) in industrial cooling water systems, oil and gas, coatings, pickling, lubricants, concrete industry, common household facilities, etc., with compositions of the disclosure.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1. An anticorrosive composition comprising:
a corrosion inhibitor;
a supramolecular host chemical or a supramolecular guest chemical configured to engage in host-guest chemistry with the corrosion inhibitor; and
a solvent.

2. The anticorrosive composition of claim 1, wherein the corrosion inhibitor comprises one or more of didecyl dimethyl ammonium chloride, benzyl alkyl pyridinyl quaternary ammonium chloride, triethyl phosphate and cinnamaldehyde mixture, polyphosphate-quaternary ammonium chloride, alkyl pyridine quaternary chloride, diethyl sulfate quaternary imidazoline, or coco-benzyl quaternary chloride.

3. The anticorrosive composition of claim 1, which further comprises a pH buffer, a colorant, an adjuvant, a stabilizer, a rheology modifier, or a combination thereof.

4. The anticorrosive composition of claim 1, wherein the corrosion inhibitor is present in an amount of about 1 percent to about 90 percent by weight of the composition.

5. The anticorrosive composition of claim 1, wherein the supramolecular host chemical or supramolecular guest chemical is present in an amount of about 1 percent to about 90 percent by weight of the composition.

6. The anticorrosive composition of claim 1, wherein the supramolecular host chemical is present and comprises a nanostructure having a charge, magnetic properties, or both.

7. The anticorrosive composition of claim 1, wherein the solvent comprises water.

8. The anticorrosive composition of claim 1, wherein the solvent is present in an amount of about 0.5 percent to about 80 percent by weight of the composition.

9. A method of preparing the anticorrosive composition of claim 1, which comprises:
forming a mixture of the solvent and the corrosion inhibitor; and
adding the supramolecular host chemical or the supramolecular guest chemical to the mixture to form the composition.

10. A method of reducing the corrosion rate of a metallic surface in contact with a fluid, which comprises:
adding an anticorrosive composition in an anti-corrosively effective amount to the fluid, the composition comprising:
a corrosion inhibitor;
a supramolecular host chemical or a supramolecular guest chemical configured to engage in host-guest chemistry with the corrosion inhibitor; and
a solvent.

11. The method of claim 10, wherein the corrosion rate of the metallic surface is reduced by at least about 10% compared to a metallic surface contacted with a fluid that does not include the anticorrosive composition.

12. The method of claim 10, wherein the corrosion rate of the metallic surface is reduced for about 30 days.

13. The method of claim 10, wherein the metallic surface comprises steel.

14. The method of claim 10, wherein the fluid comprises a brine.

15. The method of claim 10, wherein the corrosion inhibitor is selected to comprise one or more of didecyl dimethyl ammonium chloride, benzyl alkyl pyridinyl quaternary ammonium chloride, triethyl phosphate and cinnamaldehyde mixture, polyphosphate-quaternary ammonium chloride, alkyl pyridine quaternary chloride, diethyl sulfate quaternary imidazoline, or coco-benzyl quaternary chloride.

16. The method of claim 10, wherein the corrosion inhibitor is present in an amount of about 1 percent to about 90 percent by weight of the composition.

17. The method of claim 10, wherein the supramolecular host chemical or supramolecular guest chemical is present in an amount of about 1 percent to about 90 percent by weight of the composition.

18. The method of claim 10, wherein the supramolecular host chemical is present and comprises a nanostructure having a charge, magnetic properties, or both.

19. The method of claim 10, wherein the solvent comprises water.

20. The method of claim 10, wherein the solvent is present in an amount of about 0.5 percent to about 80 percent by weight of the composition.

21. The method of claim 10, which further comprises applying the fluid to a metallic surface.

22. The method of claim 10, which further comprises applying the fluid to a non-metallic surface that is later contacted with a metallic surface.
